(19) United States
(12) Patent Application Publication
(10) Pub. No.: US 2002/0060738 A1
(43) Pub. Date: May 23, 2002

(54) CCTV system

(76) Inventor: Han-Young Hong, Suwon city (KR)

Correspondence Address: Robert E. Bushnell, Suite 300, 1522 K Street, N.W., Washington, DC, 20005-1202, US

(21) Appl. No.: 09/916,245

(22) Filed: Jul. 30, 2001

(30) Foreign Application Priority Data
Nov. 20, 2000 (KR) 2000-69101

(51) Int. Cl. H04N 5/232

(52) U.S. Cl. 348/211; 348/212

(57) ABSTRACT

A CCTV system comprising a plurality of cameras, a multiplexer allotting ID information to each of the picture signals output from the plurality of cameras, the ID information being represented by a plurality of bits, and a picture signal storage medium for storing picture signals and ID information transmitted from the multiplexer, wherein the number of bits constituting the ID information is set so that the number of available IDs is twice or more than the number of cameras. With this configuration, according to the present invention, there is provided a CCTV system capable of preventing channels from being mixed while videos are being reproduced.

This application makes reference to, incorporates the same herein, and claims all benefits accruing under 35 U.S.C § 119 from an application entitled CCTV System earlier filed in the Korean Industrial Property Office on Nov. 20, 2000, and there duly assigned Serial No. 2000-69101 by that Office.

### BACKGROUND OF INVENTION

1. Field of the Invention

The present invention relates to a closed circuit television system (hereinafter, CCTV), and more particularly to, a CCTV system having an ability of preventing channels from being mixed while pictures are being reproduced.

2. Description of the Related Art

As is well known in the art, a CCTV is comprised of a plurality of cameras, a video cassette recorder (VCR) recording pictures to be reproduced for viewing, and a monitor to which photographed pictures are output for viewing.

For the VCR-recording in this CCTV system, a multiplexer is used, wherein the multiplexer assigns identification (ID) information to picture signals input, in parallel, frame by frame from the video cameras connected via a plurality of channels. The multiplexer outputs the picture signals with IDs in series. The picture signals multiplexed in series and the ID information corresponding thereto are stored together on a storage medium. When a user selects a channel, IDs are then identified to find an appropriate camera channel. When the appropriate camera channel is found, a picture signal corresponding thereto is reproduced.

Where the VCR malfunctions or a video tape is deteriorated, there is a risk of reading out wrong ID information. In the case of a time-laps VCR, which is a storage medium used as a long time monitor, a video tape therein repeats play and stop operations for continuous, but intermittent, recording. Therefore, the friction that occurs between the video tape and a head of the VCR causes the tape to deteriorate. Such deterioration poses a danger of noise being included in the ID information.

Furthermore, general ID information is comprised of 2 bits for 4 channels and 3 bits for 8 channels. The ID information is configured in a common and general way so that the number of IDs that can be configured by the various possible combinations of bits is identical to the number of camera channels. Noise introduced into the ID information may cause selection of a channel different from the desired channel. This is called a phenomenon of making channels mixed.

### SUMMARY OF THE INVENTION

Accordingly, an object of the present invention is to overcome the above-described shortcoming of mixed channels in a CCTV system.

This and other objects of the present invention may be achieved by the provision of a CCTV system comprising a plurality of cameras, a multiplexer allotting ID information to each of the picture signals output, in parallel via a corresponding plurality of camera channels, by the plurality of cameras, the ID information being represented by a plurality of bits, and a picture signal storage medium for storing the picture signals and corresponding ID information serially output from the multiplexer, wherein a number of bits constituting the ID information is set so that the number of available IDs is twice, or more, than the number of cameras or camera channels.

Preferably, the bits are comprised of proper ID bits specific to each of the cameras and auxiliary bits.

The auxiliary bits are reversed from the proper ID bits and the auxiliary bits may be identical to the proper ID bits.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a control block diagram of a CCTV system;

FIG. 2 is a table showing combinations of proper ID bits and auxiliary bits forming ID information according to the present invention; and

FIG. 3 is a table showing examples of combinations of bits forming ID information.

### DETAILED DESCRIPTION OF THE PREFERRED EMBODIMENTS

Herein below, the present invention will be described in more detail with reference to the accompanying drawings.

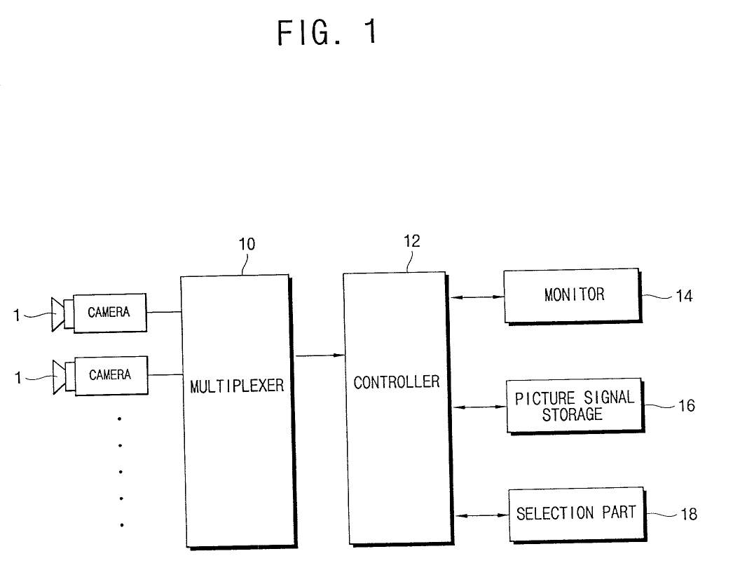

Referring to FIG. 1, which is a control block diagram of a CCTV system, the CCTV system is comprised of a plurality of cameras 1 connected through a plurality of parallel channels to a multiplexer 10 for multiplexing the picture signals input in parallel from cameras 1 for output in series, and a controller 12 for storing the multiplexed picture signals in a picture signal storage medium 16. The CCTV system further comprises a selection part 18 by which a user is allowed to input information, and a monitor 14 on which a picture signal to be displayed.

Controller 12 outputs a picture signal stored in picture signal storage medium 16 to monitor 14 according to a selection signal input from selection part 18.

Multiplexer 10 allots ID information to the picture signals input in parallel from the plurality of cameras 1 via the plurality of channels and multiplexes them in series. The ID information is to indicate from which camera the input picture signal is input, and is represented by a plurality of bits. The ID information and a picture signal corresponding thereto transmitted from multiplexer 10 are stored in the picture signal storage medium 16 by controller 12.

If a user selects, through the selection part 18, a picture signal for reproduction, the controller 12 looks for ID information stored in the picture signal storage medium 16 to locate the picture signal which the user wants reproduced.

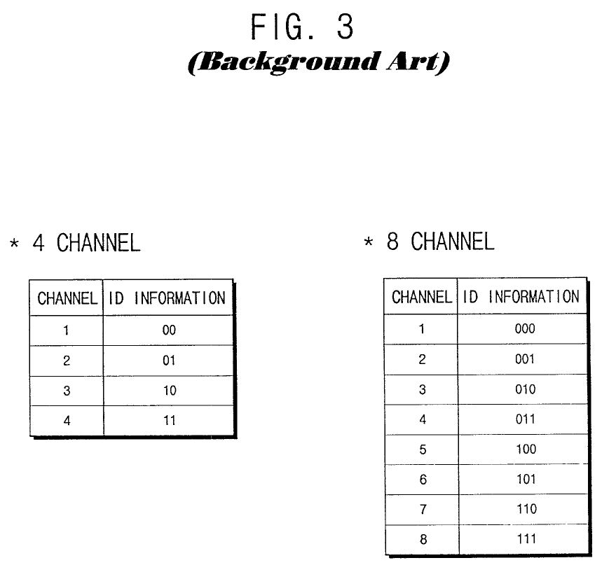

FIG. 3 illustrates an examples of ID information comprised of 2 bits for 4 channels and 3 bits for 8 channels. The ID information is configured in a common and general way so that the number of IDs that can be configured by the various possible combinations of bits is identical to the number of camera channels. Noise introduced into the ID information may cause selection of a picture signal for reproduction different from the desired picture signal.

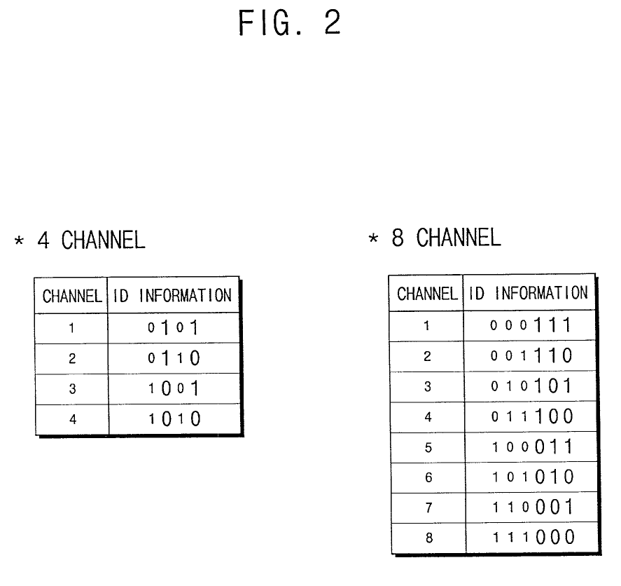

According to the present invention, ID information is constructed as shown in FIG. 2. As illustrated, the number of bits constituting ID information according to the present invention is set so that the number of available IDs is twice or more than the number of cameras 1. For example, ID information is represented by at least 4 bits in the case of four cameras 1, and it is represented by at least 6 bits in the case of eight cameras 1.

In the ID information illustrated in FIG. 2, the bits represented with lightface are bits for proper ID information, and the bits represented with boldface are auxiliary bits. The proper ID bits are information specific to each of the cameras to identify them, whereas the auxiliary bits are made by reversing the proper ID bits. However, the auxiliary bits may be constructed identically to the proper ID bits. The ID information is made by combination of the proper ID bits and the auxiliary bits.

As an example, ID information for four channels, and four cameras 1, may be constructed with a total of four bits: two of the bits are proper ID bits and the remaining two bits are auxiliary bits. If the proper ID bits for one of the channels are 01, the auxiliary bits are 10, reversed from 01. If the auxiliary bits 10 are combined with the proper ID bits 01, a complete ID is formed with 0110. Accordingly, 16 IDs can be created by combining four bits but only four of the IDs can be used as valid IDs.

As another example, ID information for eight channels, and eight cameras 1, may be constructed with a total of six bits: three of the bits are proper ID bits and the remaining three bits are auxiliary bits. If the proper ID bits for one of the channels are 010, the auxiliary bits are 101, reversed from 010. Thus, an ID of 010101 is formed by combination of the proper ID bits and the auxiliary bits. Accordingly, 64 IDs can be created by combining six bits but only eight of the IDs can be used as valid ID information.

The ID information for four channels described above is formed by alternating the auxiliary bits with the proper ID bits one by one whereas the ID information for eight channels formed by combining the auxiliary bits and the proper ID bits utilizes the auxiliary bits as the three least significant bits of the combination and the proper ID bits as the three most significant bits of the combination. However, the combination of the proper ID bits and the auxiliary bits may be arbitrarily made for the sake of user's convenience.

With this configuration, some of bit combinations for available IDs can only be used as valid ID informations and a difference of two or more bits can be created between valid ID informations. Accordingly, channel mixture resulting from incorrectly reading out the ID information selected by the user can be prevented.

As described above, according to the present invention, there is provided a CCTV system capable of preventing channels from being mixed while videos are being reproduced.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A closed circuit television (CCTV) system comprising:
a number of cameras for generating picture signals;
a multiplexer allotting identification information to each of the picture signals received from the cameras, said identification information being represented by a predetermined number of bits SO that a number of available identifications is twice or more than the number of the cameras, said identification information comprising a plurality of proper identification bits and a corresponding plurality of auxiliary bits, characterized in that the proper identification bits identify which camera generated a corresponding picture signal; and
a picture signal storage medium for storing the picture signals and allotted identification information output from the multiplexer.

2. The CCTV system as set forth in claim 1, wherein said multiplexer is a parallel to serial multiplexer.

3. The CCTV system as set forth in claim 1, wherein the picture signal storage medium comprises a single video tape in a single video tape recorder.

4. The CCTV system as set forth in claim 1, wherein the picture signal storage medium comprises a single digital storage medium.

5. The CCTV system as set forth in claim 1, further comprising:
a monitor for displaying picture signals reproduced by said picture signal storage medium; and
a selection unit for enabling a user to select picture signals corresponding to a particular one of said cameras for display on said monitor by inputting the identification information corresponding to said particular one of said cameras.

6. The CCTV system as set forth in claim 5, further comprising:
a controller for storing said picture signals and said identification information in said picture signal storage medium, said controller being responsive to a selection signal generated by said selection unit for selecting the picture signals corresponding to said particular one of said cameras and stored in said picture signal storage medium and outputting the selected picture signals for display on said monitor.

7. The CCTV system as set forth in claim 1, wherein the logical values of said auxiliary bits are opposite to the logical values of said proper identification bits.

8. The CCTV system as set forth in claim 7, wherein the number of cameras is four and the identification information comprises two said proper identification bits and two said auxiliary bits.

9. The CCTV system as set forth in claim 8, wherein said proper identification bits and said auxiliary bits are disposed in an alternating arrangement such that said auxiliary bits are the least significant and second most significant bits in said arrangement and said proper identification bits are the second least significant bits and the most significant bit in said arrangement.

10. The CCTV system as set forth in claim 7, wherein the number of cameras is eight and the identification information comprises three said proper identification bits and three said auxiliary bits.

11. The CCTV system as set forth in claim 10, wherein said proper identification bits and said auxiliary bits are disposed in an predetermined arrangement such that said auxiliary bits are the least significant bits in said arrangement and said proper identification bits are the most significant bit in said arrangement.

12. The CCTV system as set forth in claim 1, wherein the logical values of said auxiliary bits are identical to the logical values of said proper identification bits.

13. The CCTV system as set forth in claim 12, wherein the number of cameras is four and the identification information comprises two said proper identification bits and two said auxiliary bits.

14. The CCTV system as set forth in claim 13, wherein said proper identification bits and said auxiliary bits are disposed in an alternating arrangement such that said auxiliary bits are the least significant and second most significant bits in said arrangement and said proper identification bits are the second least significant bits and the most significant bit in said arrangement.

15. The CCTV system as set forth in claim 12, wherein the number of cameras is eight and the identification information comprises three said proper identification bits and three said auxiliary bits.

16. The CCTV system as set forth in claim 15, wherein said proper identification bits and said auxiliary bits are disposed in an predetermined arrangement such that said auxiliary bits are the least significant bits in said arrangement and said proper identification bits are the most significant bit in said arrangement.

17. A closed circuit television (CCTV) system comprising:
a number of cameras for generating picture signals;
a multiplexer allotting identification information to each of the picture signals received from the cameras, said identification information being represented by a predetermined number of bits so that a number of available identifications is twice or more than the number of the cameras; and
a picture signal storage medium for storing the picture signals and allotted identification information output from the multiplexer.

18. The CCTV system as set forth in claim 15, wherein said identification information comprises a plurality of proper identification bits specific to each of the cameras and a corresponding plurality of auxiliary bits.

19. The CCTV system according to claim 18, wherein the logical values of the auxiliary bits are reversed from the logical values of the proper identification bits.

20. The CCTV system according to claim 18, wherein the logical values of the auxiliary bits are identical to the logical values of the proper identification bits.
